(19) United States
(12) Patent Application Publication
(10) Pub. No.: US 2022/0004950 A1
(43) Pub. Date: Jan. 6, 2022

(54) DISTRIBUTED ORCHESTRATION FOR SATELLITE GROUPS AND OTHER GROUPS

(71) Applicant: Raytheon Company, Waltham, MA (US)

(72) Inventor: H. Brown Cribbs, III, Arlington, VA (US)

(21) Appl. No.: 17/308,373

(22) Filed: May 5, 2021

Related U.S. Application Data
(60) Provisional application No. 62/705,536, filed on Jul. 2, 2020.

(51) Int. Cl. G06Q 10/06; G06Q 30/08; G05B 19/4155; B64G 1/10

(52) U.S. Cl. CPC G06Q 10/06312; G06Q 30/08; G05B 2219/23297; G05B 19/4155; B64G 1/10; G06Q 10/06313

(57) ABSTRACT

A method includes receiving, at a specified device among a plurality of devices, a first request to perform a first task. The method also includes transmitting multiple bid requests associated with the first task to multiple other devices among the plurality of devices. The method further includes receiving, at the specified device, at least one bid response from at least one of the other devices. In addition, the method includes assigning performance of the first task to one or more of the plurality of devices based on the at least one bid response. Each bid response may include a quality and a timeliness associated with the one of the devices' ability to perform the first task. Multiple bid responses may be received, and the method may further include ranking the bid responses based on at least one quality or timeliness factor identified by a party providing the first request.

### CROSS-REFERENCE TO RELATED APPLICATION AND PRIORITY CLAIM

This application claims priority under 35 U.S.C. § 119(e) to U.S. Provisional Patent Application No. 62/705,536 filed on Jul. 2, 2020, which is hereby incorporated by reference in its entirety.

### TECHNICAL FIELD

This disclosure relates generally to satellite systems. More specifically, this disclosure relates to distributed orchestration for satellite groups and other groups.

### BACKGROUND

Various types of satellites are often used in groups (constellations), where different satellites in the same constellation can perform the same functions, such as the same data collection functions. The identification of specific tasks to be performed by specific satellites in a constellation is often referred to as orchestration. With multiple collection opportunities (options), the job of orchestration and assigning which satellite will perform a given task generally has been done on the ground by a centralized planning and scheduling system. For example, prior approaches have used a centralized orchestrator to manage a constellation of satellites. However, the planning problem becomes more arduous for a centralized planner to resolve as the constellation grows.

### SUMMARY

This disclosure relates to distributed orchestration for satellite groups and other groups.

In a first embodiment, a method includes receiving, at a specified device among a plurality of devices, a first request to perform a first task. The method also includes transmitting multiple bid requests associated with the first task to multiple other devices among the plurality of devices. The method further includes receiving, at the specified device, at least one bid response from at least one of the other devices. In addition, the method includes assigning performance of the first task to one or more of the plurality of devices based on the at least one bid response.

In a second embodiment, a device includes at least one processor configured to receive a first request to perform a first task and initiate transmission of multiple bid requests associated with the first task to multiple other devices. The at least one processor is also configured to receive at least one bid response from at least one of the other devices and assign performance of the first task to one or more of the plurality of devices based on the at least one bid response.

In a third embodiment, a non-transitory computer readable medium contains instructions that when executed cause at least one processor to receive, at a specified device among a plurality of devices, a first request to perform a first task. The medium also contains instructions that when executed cause the at least one processor to initiate transmission of multiple bid requests associated with the first task to multiple other devices among the plurality of devices. The medium further contains instructions that when executed cause the at least one processor to receive, at the specified device, at least one bid response from at least one of the other devices. In addition, the medium contains instructions that when executed cause the at least one processor to assign performance of the first task to one or more of the plurality of devices based on the at least one bid response.

In a fourth embodiment, a method includes receiving, at a specified device from an auctioneer device, a request associated with a task to be performed. The method also includes determining that the specified device is capable of performing the task and transmitting a bid response to the auctioneer device. The method further includes, in response to acceptance of the bid response by the auctioneer device, performing the task at the specified device.

A device may include at least one processor configured to perform the method of the fourth embodiment. A non-transitory computer readable medium may contain instructions that when executed cause at least one processor to perform the method of the fourth embodiment.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example system supporting distributed orchestration for a satellite group or other group according to this disclosure;

FIG. 2 illustrates an example device or system supporting distributed orchestration for a satellite group or other group according to this disclosure;

FIGS. 3A and 3B illustrate an example process supporting auctioning as part of distributed orchestration for a satellite group or other group according to this disclosure;

FIG. 4 illustrates an example process supporting bidding and task execution as part of distributed orchestration for a satellite group or other group according to this disclosure;

FIG. 5 illustrates an example sequence diagram supporting distributed orchestration for a satellite group or other group according to this disclosure;

FIG. 6 illustrates an example activity diagram supporting distributed orchestration for a satellite group or other group according to this disclosure;

FIG. 7 illustrates an example method for use by an auctioneering satellite or other device to support distributed orchestration for a satellite group or other group according to this disclosure; and

FIG. 8 illustrates an example method for use by a participant satellite or other device to support distributed orchestration for a satellite group or other group according to this disclosure.

### DETAILED DESCRIPTION

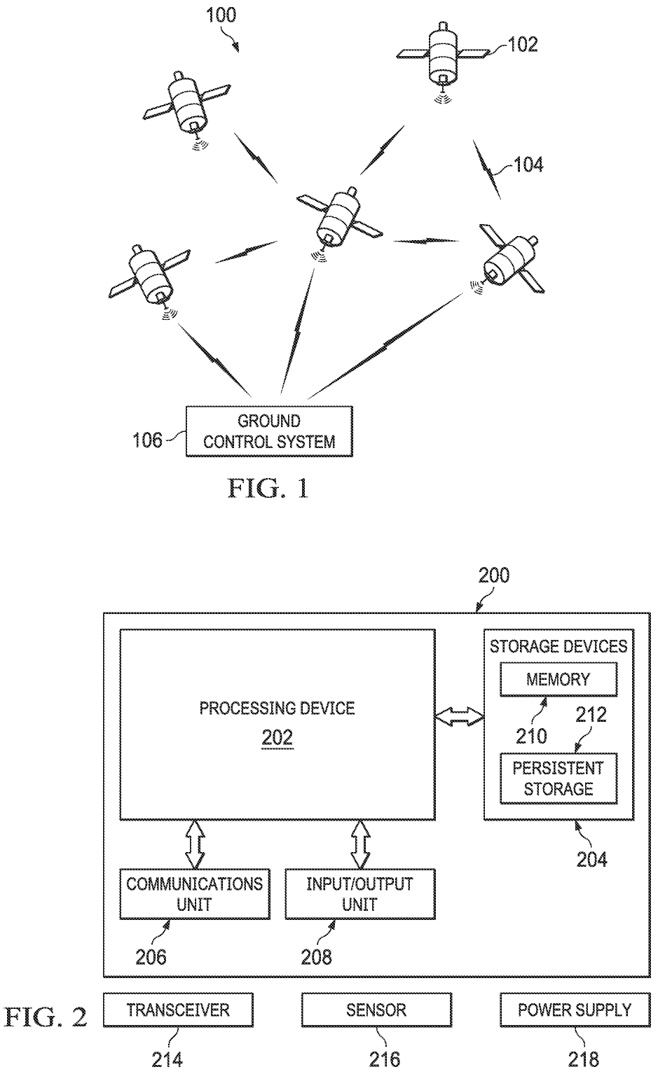

FIGS. 1 through 8, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

As noted above, various types of satellites are often used in groups (constellations), where different satellites in the same constellation can perform the same functions, such as the same data collection functions. The identification of specific tasks to be performed by specific satellites in a constellation is often referred to as orchestration. With multiple collection opportunities (options), the job of orchestration and assigning which satellite will perform a given task generally has been done on the ground by a centralized planning and scheduling system. For example, prior approaches have used a centralized orchestrator to manage a constellation of satellites. However, the planning problem becomes more arduous for a centralized planner to resolve as the constellation grows. The use of larger numbers of satellites can therefore require that scheduling be done in-orbit by collections of the satellites in order to share the burden of all collection goals or other goals.

This disclosure provides an auction-style planning and scheduling system for satellite groups that supports disaggregated orchestration. Disaggregated orchestration solves the problem of distributing tasks among a collection of satellites or other devices using an auction process, where each satellite or other device can evaluate its ability to satisfy a task request. For example, an “auctioneer” satellite may initiate a request for bids from other “participant” satellites, and each participant satellite may choose whether or not to respond to the request with a bid. Each satellite's ability to satisfy a request can be based on the ability of the satellite to fulfill the request. For instance, each satellite's ability to satisfy a request can be determined based on various criteria, such as each satellite's access (time and space) for a requested data collection and/or data quality for a requested data collection. Other criteria can include each satellite's own internal pending scheduled activities and priorities of those activities. In some embodiments, the satellites used in a group may represent smaller satellites having relatively limited resources, although the same approaches may be used with larger satellites having relatively larger amounts of resources or other devices.

Concentrating on the capabilities of individual satellites, the satellites can receive a request for bid, and the individual satellites can assess whether they can fulfill the request. If a satellite cannot, the satellite can refrain from submitting a bid, which may be referred to as a “no-bid” action. If a satellite assesses that it has the sensing or other capability, access, and priority that would permit the requested data collection or other operation, the satellite can submit a “bid.” In some embodiments, each bid has two components (quality and timeliness) so that the auctioneer can select the best offer from bids that are returned. Both quality and timeliness may relate to data collection, meaning a satellite may generate a bid based on that satellite's quality of data collection and timeliness of data collection. Also, in some embodiments, the quality of data collection can be based on the use of a feasibility engine that models a given satellite's sensing or acting capabilities against a request, where the feasibility establishes the physical expected performance of a sensor system considering geometry and subject characteristics of the satellite. The “winning” satellite(s) can be assigned the task(s) based on the bid(s) received by the auctioneer. Satellites manage their own schedules internally, and each task is added to the winning satellite's task schedule. Note here that there is no centralized scheduling of action; rather, a singular request from outside the local group of satellites can contain information, which is then auctioned as an opportunity. Also note that the disaggregated orchestration operations here can be performed using low-bandwidth inter-communications between autonomous satellites to perform auctions and assign tasks.

The role of “auctioneer” can rotate or otherwise change among satellites in a group, thereby providing a resilient mechanism to perform orchestration. For instance, the failure of a satellite acting as an auctioneer for one request may not prevent the group of satellites from fulfilling subsequent requests since one or more other satellites may step in and assume the role of auctioneer. It is also possible for different satellites to function as auctioneers for different requests. This means that the same satellite may (i) function as an auctioneer and receive bids from other satellites for some requests and (ii) function as a participant and provide bids to other satellites for other requests.

In this way, auctions may be used to distribute tasking requests among multiple satellites in a group. The auctioneer role may be run by any satellite in a group that can perform a given task, such as by selecting the satellite that receives a request from the ground or other external source to act as the auctioneer. Each satellite can manage its own schedule and consider collection opportunities with respect to existing scheduled task priorities. Bid/no-bid decisions can be based on factors such as capability to collect (correct sensor), access (time-space), scheduling priority, and quality of collection (feasibility). The selection by the auctioneer of a winning bid (at least one satellite to perform a task) can be based on factors such as request type (quality with flexible time window or time-critical with minimum quality defined). Preferences for quality and/or timeliness priority can be specified by a requestor, meaning the party requesting that a task be performed.

Note that while tasks to be performed by satellites are often described as involving data collection, this need not be the case. Satellites may be able to perform various types of functions, and auction-based disaggregated orchestration may be used to assign any suitable types of tasks to any suitable numbers of satellites. Thus, while data collection may be described here as an example task to be auctioned performed, this is for illustration only and does not limit the scope of this disclosure. Also note that while auction-based disaggregated orchestration is often described as being used to assign tasks that are performed by satellites, the same or similar techniques may be used to assigned tasks performed by other groups of devices. Examples of other devices may include swarms or other groups of unmanned aerial vehicles (UAVs), unmanned underwater vehicles (UUVs), or proliferated low-Earth orbit (LEO) satellites or other LEO devices. Thus, disaggregated orchestration can be used to provide scalable command and control for various types of autonomous systems, and this disclosure is not limited to use with satellites.

FIG. 1 illustrates an example system 100 supporting distributed orchestration for a satellite group or other group according to this disclosure. As shown in FIG. 1, the system 100 includes a collection of satellites 102, which may form a constellation. Each satellite 102 in the constellation may be configured to perform one or more functions on behalf of one or more requesting parties. For example, in some embodiments, the satellites 102 in the constellation may be configured to use identical, similar, or dissimilar sensor systems to perform data collection operations. In some cases, the satellites 102 may be able to collect the same or similar types of data, but the characteristics of the data collection by different satellites 102 may differ (such as in terms of quality or speed). In other embodiments, the satellites 102 in the constellation may be configured to perform other functions. Each satellite 102 includes any suitable space-based vehicle configured to orbit the Earth or other celestial body and perform one or more functions. While five satellites 102 are shown in FIG. 1 as forming a constellation, any suitable number of satellites 102 may be used to form any suitable number of constellations. Also, the form factor of the satellites 102 may differ from the one shown here.

The satellites 102 are configured to engage in wireless communications 104 with one another and with one or more external devices or systems, such as a ground control system 106. The wireless communications 104 may be used to transport any suitable information between the satellites 102 or between the satellites 102 and the one or more external devices or systems. Among other things, the wireless communications 104 may allow the satellites 102 to exchange information used to support distributed orchestration operations as described in this patent document. In some cases, the disaggregated orchestration operations can be performed using low-bandwidth inter-satellite wireless communications 104, such as to perform auctions and assign tasks. Any suitable radio frequency (RF), optical, or other communications may be used as the wireless communications 104 between or involving the satellites 102.

The ground control system 106 represents one example external source of information for or destination of information from one or more satellites 102. For example, the ground control system 106 may provide information defining one or more tasks to be performed, which may initiate disaggregated orchestration operations as discussed below. The ground control system 106 may also receive the results of the one or more tasks after performance by one or more of the satellites 102. Note that while a single ground control system 106 is shown here, the satellites 102 may communicate with any suitable number(s) and type(s) of land-, water-, air-, or space-based devices or systems.

As described in more detail below, the satellites 102 collectively support auction-based disaggregated orchestration that allows tasks to be assigned to and performed by the satellites 102. For each task or collection of tasks to be performed, one of the satellites 102 may be assigned the role of auctioneer. For instance, the satellite 102 to receive information defining the task(s) to be performed from the ground control system 106 or other external source may be assigned the role of auctioneer. The auctioneer satellite 102 can send a request to other participant satellites 102 for bids, and the auctioneer satellite 102 may receive one or more bids from one or more of the participant satellites 102. The auctioneer satellite 102 may also generate its own bid.

To generate a bid, each satellite 102 may analyze one or more criteria and determine whether it can perform the one or more tasks. Any suitable criteria may be used by each satellite 102 to determine whether it can perform the one or more tasks, such as the satellite's access (in time and space), data quality, internal pending scheduled activities, and priorities. If able to perform the task(s), the satellite 102 may generate a bid that identifies various information, such as (in the data collection scenario) a time when the data collection may be performed or completed and the quality of the data that may be collected.

After receiving bids (possibly including its own bid), the auctioneer satellite 102 can analyze the bids and select at least one winning bid. The auctioneer satellite 102 may use any suitable criteria in selecting a winning bid. For example, in some cases, the auctioneer satellite 102 may select a bid that indicates a desired quality of data collection may be achieved by a specific satellite 102 within a flexible time window. In other cases, the auctioneer satellite 102 may select a bid that indicates a minimum quality of data collection may be achieved by a specific satellite 102 within a fixed time-critical window. In some embodiments, the criteria used to select the winning bid may be specified by the party requesting performance of the task(s). Once at least one winning bid is selected, the auctioneer satellite 102 can assign the task(s) to the satellite(s) 102 that provided the winning bid(s) for execution. In some cases, the satellite(s) 102 that provided the winning bid(s) may be able to accept or reject the assignment of the task(s) for execution.

As noted above, the role of auctioneer can vary over time. For example, if the auctioneer role is assigned to the satellite 102 that first receives a request for performance of one or more tasks from an external source, the satellite 102 acting as the auctioneer can vary if the external source is able to communicate with different satellites 102. Also, each satellite 102 may act as an auctioneer for some task assignments and only as a participant for other task assignments.

Although FIG. 1 illustrates one example of a system 100 supporting distributed orchestration for a satellite group or other group, various changes may be made to FIG. 1. For example, the system 100 may include any suitable number of satellites 102 in any suitable arrangement, and the satellites 102 may form any suitable number of constellations. Also, the satellites 102 may communicate with any other suitable external sources or destinations. In addition, while described as involving a group of satellites 102, the same or similar distributed orchestration operations described above may be used with other types of devices.

FIG. 2 illustrates an example device or system 200 supporting distributed orchestration for a satellite group or other group according to this disclosure. The device or system 200 may, for example, be implemented in each satellite 102 of a constellation or other device of a group and used to perform distributed orchestration operations. For ease of explanation, the device or system 200 is described as being used in the satellites 102 in the system 100 of FIG. 1. However, the distributed orchestration operations may be used in any suitable satellites or other devices and in any other suitable systems.

As shown in FIG. 2, the device or system 200 may include at least one processing device 202, at least one storage device 204, at least one communications unit 206, and at least one input/output (I/O) unit 208. The processing device 202 may execute instructions that can be loaded into a memory 210. The processing device 202 includes any suitable number(s) and type(s) of processors or other processing devices in any suitable arrangement. Example types of processing devices 202 include one or more microprocessors, microcontrollers, digital signal processors (DSPs), application specific integrated circuits (ASICs), field programmable gate arrays (FPGAs), or discrete circuitry.

The memory 210 and a persistent storage 212 are examples of storage devices 204, which represent any structure(s) capable of storing and facilitating retrieval of information (such as data, program code, and/or other suitable information on a temporary or permanent basis). The memory 210 may represent a random access memory or any other suitable volatile or non-volatile storage device(s). The persistent storage 212 may contain one or more components or devices supporting longer-term storage of data, such as a read only memory, hard drive, Flash memory, or optical disc.

The communications unit 206 supports communications with other systems or devices. The communications unit 206 may support communications through any suitable physical or wireless communication link(s), such as a network or dedicated connection(s). As a particular example, the communications unit 206 may support communications with cameras and lasers.

The I/O unit 208 allows for input and output of data. For example, the I/O unit 208 may provide connections for inputs of signals from and outputs of signals to other components of a satellite. Note that the number(s) and type(s) of inputs and outputs of the I/O unit 208 can vary as needed or desired, such as based on the other components present in the satellite.

The device or system 200 may provide any desired functionality within a larger device or system. For example, the device or system 200 may receive a request from an external source (such as a ground control system 106 or other ground-based or other source) and function as an auctioneer to provide requests to multiple satellites 102, receive bids/no-bids from the multiple satellites 102, and assign at least one task to at least one satellite 102 for performance based on the bids. The auctioneer satellite 102 may also generate and consider its own bid when assigning at least one task. As another example, the device or system 200 may receive a request from an auctioneer, provide a bid/no-bid response to the auctioneer, and (possibly) perform the requested task(s) if the bid is accepted.

Each satellite 102 or other device may include any additional components designed to provide desired functionality in the satellite 102 or other device. For example, each satellite 102 or other device may include one or more transceivers 214 and related circuitry or other components configured to communicate with external devices, such as ground-based antennas and other satellites 102 or other devices. Each satellite 102 or other device may include one or more imaging sensors or other sensors 216 and related circuitry or other components configured to perform one or more data collection operations related to any specific characteristic(s) to be sensed. Each satellite 102 or other device may include one or more power supplies 218 and related circuitry or other components configured to provide operating power to other components of the satellite 102 or other device. Note, however, that the specific makeup and arrangement of the satellites 102 or other devices in a group can vary as needed or desired, and the satellites 102 or other devices may have a common design or different designs.

Although FIG. 2 illustrates one example of a device or system 200 supporting distributed orchestration for a satellite group or other group, various changes may be made to FIG. 2. For example, computing and communication devices and systems, as, well as satellites, come in a wide variety of configurations. As a result, FIG. 2 does not limit this disclosure to any particular computing or communication device or system or to any particular type of satellite. Also, while often described as being used in satellites 102, the same or similar device or system 200 may be used in other types of devices.

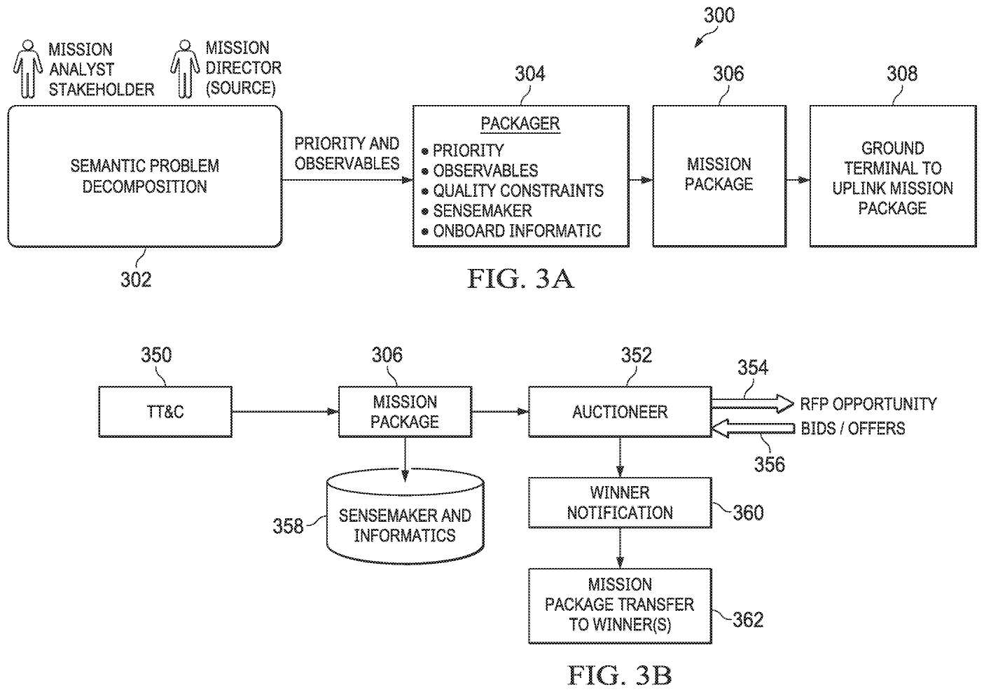

FIGS. 3A and 3B illustrate an example process 300 supporting auctioning as part of distributed orchestration for a satellite group or other group according to this disclosure. For ease of explanation, the process 300 is described as being used with the satellites 102 in the system 100 of FIG. 1. However, the process 300 may be used with any other suitable satellites or other devices and in any other suitable systems.

As shown in FIG. 3A, semantic problem decomposition 302 is used to identify one or more parameters associated with at least one task to be performed using at least one satellite 102 or other device. For example, the semantic problem decomposition 302 may involve identifying the priority of at least one task to be performed and the type(s) of results to be obtained from the one or more satellites 102 or other devices that actually perform the at least one task. In the context of data collection, for instance, the type of results to be obtained may include the type of data to be collected (referred to as “observables”). The identification of the task(s) to be performed and the type(s) of results to be obtained may occur in any suitable manner, such as based on input from one or more mission analyst stakeholders, mission directors, or other personnel.

The information from the semantic problem decomposition 302 is provided to a packager 304, which uses this and other information to generate a mission package 306. For example, the packager 304 can include an identification of one or more priorities and one or more observables in the mission package 306. The one or more priorities may indicate, for instance, a time window in which the one or more observables are needed or an indication that the one or more observables should be obtained as soon as possible. The packager 304 can also include an identification of one or more quality constraints associated with the observable(s), such as by defining one or both of the maximum quality and the minimum quality to be used when performing a data collection operation or other task(s).

The packager 304 can further include an identification of parameters for sensemaker and onboard informatics capabilities of one or more satellites 102 or other devices to be used to perform the task(s). In some embodiments, each satellite 102 or other device may include or implement a sensemaker, which represents a high-level decision engine that processes information and determines the next course of action for the satellite 102 or other device (which can be based on information from an informatics process). Each satellite 102 or other device may also include or implement onboard informatics processing, which represents a low-level processing element that receives raw sensor data and turns the raw data into information usable by the sensemaker to formulate a course of action. As a particular example of this, informatics might receive an RF signal and perform necessary operations to detect, demodulate, and format a message from raw RF samples, and the message (or merely the fact that a message was detected) can be reported to the sensemaker for action.

Collectively, the information in the mission package 306 may represent all capabilities and other information that might be needed for execution of the task(s) by one or more satellites 102 or other devices. In this example, the mission package 306 can be provided to a ground terminal 308, which supports an uplink channel for communication of the mission package 306 to one or more satellites 102 or other devices.

As shown in FIG. 3B, a satellite 102 includes a telemetry, tracking, and control (TT&C) subsystem 350, which provides a communication connection between the satellite 102 and an external device or system (such as the ground terminal 308). The TT&C subsystem 350 allows the satellite 102 to receive the mission package 306, which can be used by an auctioneer process 352 to generate one or more requests 354 transmitted to other satellites 102. The one or more requests 354 may include various information from the mission package 306, such as an identification of one or more tasks to be performed. This allows at least one of the other satellites 102 to generate a bid or offer 356 for performing the task(s) associated with the mission package 306. Any received bid or offer 356 may identify the satellite 102 providing the bid or offer 356 and any parameters associated with the bid or offer 356, such as the responding satellite's proposed quality for the task(s) or the time by which the responding satellite's performance of the task(s) may be completed. The mission package 306 may also be used by the auctioneer satellite 102 itself to determine whether its sensemaker and onboard informatics 358 can be used to satisfy the mission package 306, in which case the auctioneer satellite 102 may itself generate an additional bid or offer 356.

The auctioneer process 352 can analyze the received bids or offers 356 and select at least one winning bid or offer 356. A winning bid or offer 356 can be selected based on any suitable criteria, such as timeliness, quality, and/or other factors. A notification operation 360 involves notifying the satellite(s) 102 that won the auction of their winning status, and a transfer operation 362 involves transferring the mission package 306 to the winning satellite(s) 102 for execution of the one or more tasks. Note that these operations assume the auctioneer satellite 102 is not the winner of the auction. If the auctioneer satellite 102 is the winner of the auction, the auctioneer satellite 102 can perform the one or more tasks without, for example, transferring the mission package 306 to another satellite 102.

The various operations shown in FIG. 3B may be implemented in any suitable manner within a satellite 102 or other device. For example, the satellite 102 may include dedicated hardware or a combination of hardware and software/firmware instructions that are used to perform one or more functions of the satellite 102 shown in FIG. 3B. As a particular example, the satellite 102 may execute software/firmware instructions using at least one processing device 202 to perform various operations shown in FIG. 3B. However, this disclosure is not limited to any particular physical implementation of the satellite 102.

Although FIGS. 3A and 3B illustrate one example of a process 300 supporting auctioning as part of distributed orchestration for a satellite group or other group, various changes may be made to FIGS. 3A and 3B. For example, a mission package 306 may be produced in any other suitable manner and may be provided to a satellite 102 or other device in any other suitable manner. Also, it is assumed here that the satellite 102 initially receiving the mission package 306 may function as the auctioneer satellite 102. However, in other cases, the satellite 102 initially receiving the mission package 306 may transfer the mission package 306 to another satellite 102 that functions as the auctioneer satellite 102. In addition, while described as involving a satellite 102, the same or similar operations described in FIGS. 3A and 3B may be used with other types of devices.

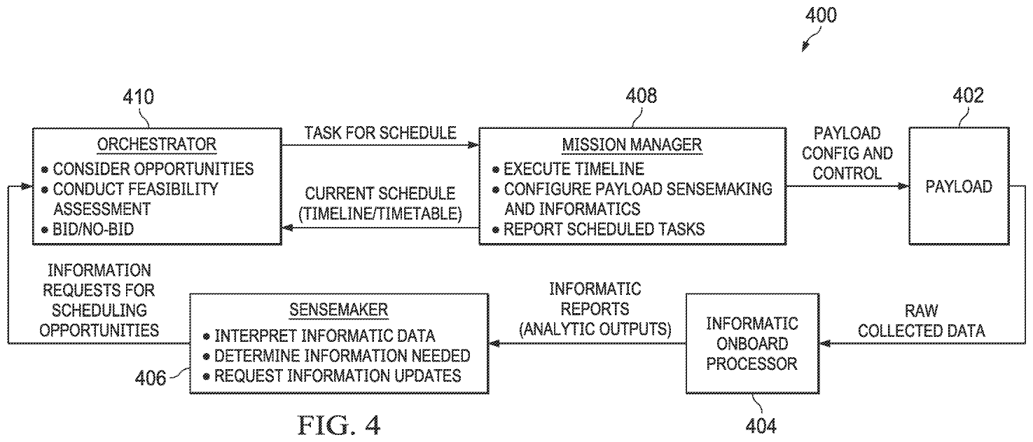

FIG. 4 illustrates an example process 400 supporting bidding and task execution as part of distributed orchestration for a satellite group or other group according to this disclosure. For ease of explanation, the process 400 is described as being used with the satellites 102 in the system 100 of FIG. 1. However, the process 400 may be used with any other suitable satellites or other devices and in any other suitable systems.

As shown in FIG. 4, the satellite 102 or other device includes a payload 402, an informatic onboard processor 404, and a sensemaker 406. The payload 402 may include one or more sensors 216 or other components used by the satellite 102 or other device to perform one or more specific functions, such as one or more data collection functions. The informatic onboard processor 404 can process data from the payload 402 to generate reports or other analytic outputs based on the processing. The sensemaker 406 can use the reports or other analytic outputs from the informatic onboard processor 404 to determine a course of action for the satellite 102 or other device. For instance, the sensemaker 406 can interpret the outputs from the informatic onboard processor 404 and determine whether additional information is needed or whether information updates should be requested from the payload 402.

In this example, a mission manager 408 controls the overall operations of the satellite 102 or other device. For example, the mission manager 408 can schedule a timeline of tasks and configure the payload 402, informatic onboard processor 404, and sensemaker 406 as needed to perform the tasks in the timeline. The mission manager 408 may also, upon request, provide an identification of any tasks that are currently scheduled for execution by the satellite 102 or other device, such as in the form of a timeline or timetable.

An orchestrator 410 is used to identify additional tasks that can be provided to the mission manager 408 for scheduling and execution. Some of the additional tasks identified by the orchestrator 410 may be based on outputs from the sensemaker 406, such as when the sensemaker 406 determines that additional information or updates are needed from the payload 402 for currently-executing tasks. Others of the additional tasks identified by the orchestrator 410 may be based on requests received from one or more auctioneer satellites 102, where the orchestrator 410 determines whether to bid or not bid on the requests and (if won) to initiate scheduling and performance of the tasks associated with winning bids submitted by the orchestrator 410.

In some embodiments, the orchestrator 410 implements a feasibility engine that models the particular satellite's sensing or acting capabilities. When a request from an auctioneer satellite 102 is received, the feasibility engine can be used to perform a feasibility assessment and determine (i) whether the requested task(s) can be performed and (ii) if so, what the expected results of performing the task(s) might be. For instance, in a data collection scenario, the feasibility engine may use the capabilities of the satellite's sensor(s) 216 and the location of the satellite 102 relative to an area to be scanned in order to estimate the quality of the sensor measurements that might be obtained and when. The orchestrator 410 can also consider other tasks currently scheduled for execution by the satellite 102 and determine whether it would be possible to add one or more additional tasks and/or reschedule any already-scheduled tasks for execution on the satellite 102. Assuming the requested task(s) can be performed, the orchestrator 410 may then construct a bid based on the feasibility of the satellite 102 in performing the task(s) defined by the request based on the capabilities of the satellite 102. If the bid is accepted, the orchestrator 410 can provide the task(s) for the request to the mission manager 408 for scheduling and execution.

The various operations shown in FIG. 4 may be implemented in any suitable manner within a satellite 102 or other device. For example, the satellite 102 may include dedicated hardware or a combination of hardware and software/firmware instructions that are used to perform one or more functions of the satellite 102 shown in FIG. 4. As a particular example, the satellite 102 may execute software/firmware instructions using at least one processing device 202 to perform various operations shown in FIG. 4. However, this disclosure is not limited to any particular physical implementation of the satellite 102.

Although FIG. 4 illustrates one example of a process 400 supporting bidding and task execution as part of distributed orchestration for a satellite group or other group, various changes may be made to FIG. 4. For example, a satellite 102 may use any other suitable technique in determining if and how to respond to a request from an auctioneer satellite 102. Also, the satellite 102 may use any other suitable technique to schedule tasks and use any other suitable components to perform the scheduled tasks. In addition, while described as involving a satellite 102, the same or similar operations described in FIG. 4 may be used with other types of devices.

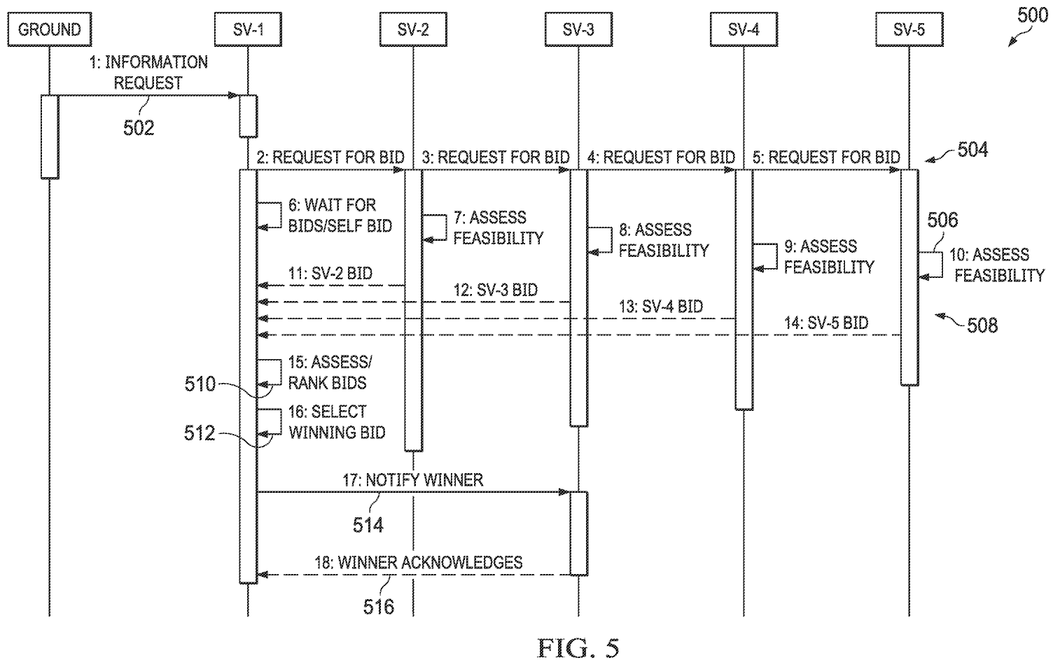

FIG. 5 illustrates an example sequence diagram 500 supporting distributed orchestration for a satellite group or other group according to this disclosure. For ease of explanation, the sequence diagram 500 is described as being used with the satellites 102 in the system 100 of FIG. 1. However, the sequence diagram 500 may be used with any other suitable satellites or other devices and in any other suitable systems. Note that in FIG. 5, individual satellites 102 are identified using “SV” labels, which stand for “satellite vehicle.” Also, note that in FIG. 5, it is assumed at least one task is being initiated in response to information from a ground station, such as the ground control system 106. However, as described above, information initiating one or more tasks may be received from any other suitable source(s).

As shown in FIG. 5, an information request 502 is provided from the ground source or other source to one of the satellites 102 (SV-1 in this example). The first satellite assumes the role of auctioneer, so the first satellite sends requests 504 for bids to other satellites 102 (SV-2 through SV-5 in this example). The other satellites 102 perform feasibility assessments 506 in order to determine whether the other satellites 102 can perform the task(s) of the information request 502. If determined to be feasible, each of the other satellites 102 generates and transmits a bid 508 to the auctioneer satellite 102 based on its feasibility assessment 506.

The auctioneer satellite 102 performs an assessment and/or ranking 510 of any received bids 508, which can include assessing and/or ranking any bid generated by the auctioneer satellite 102 itself. The bids may be ranked in any suitable manner, such as based on the quality of data collection and/or the timeliness of providing collected data. A selection 512 of a winning bid is made by the auctioneer satellite 102, and a notification 514 is provided to inform the winning satellite 102 (SV-3 in this example) that it won the auction. An acknowledgement 516 that the winning satellite 102 has won the auction and can perform the task(s) of the information request 502 can be sent to the auctioneer satellite 102. At this point, any other suitable actions may occur, such as sending the mission package from the auctioneer satellite 102 to the winning satellite 102. Note that the winning satellite 102 might instead reject the notification 514 (such as due to changed circumstances of the winning satellite 102), in which case the auctioneer satellite 102 may select the next-ranked bid (if any) for acceptance and transmit a notification 514 to a different winning satellite 102.

Although FIG. 5 illustrates one example of a sequence diagram 500 supporting distributed orchestration for a satellite group or other group, various changes may be made to FIG. 5. For example, the sequence diagram 500 may involve any suitable number of satellites 102. Also, while it is assumed that the initial satellite 102 receiving the information request 502 becomes the auctioneer, this may not necessarily be the case. In addition, while described as involving satellites 102, the same or similar operations described in FIG. 5 may be used with other types of devices.

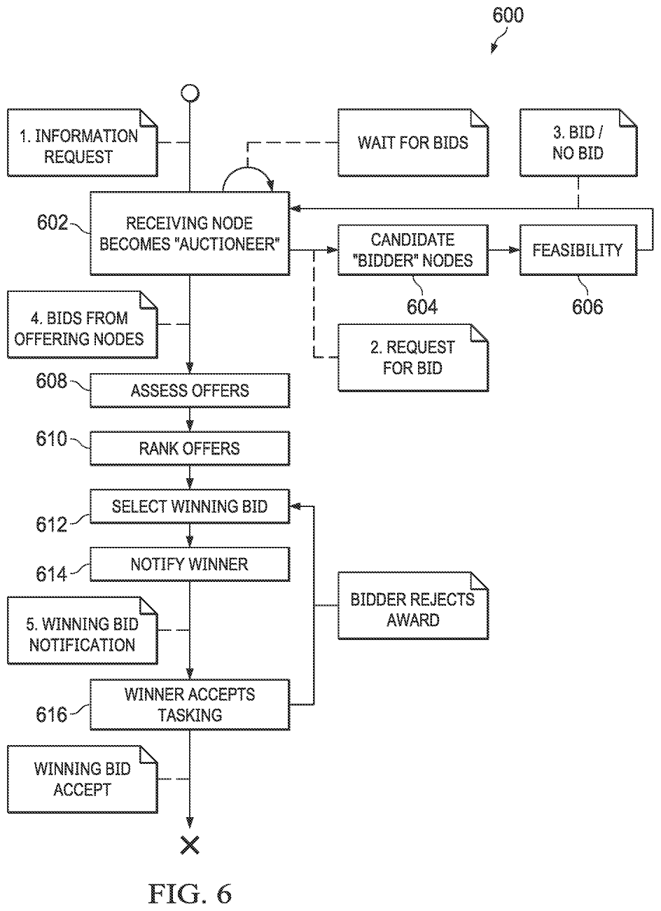

FIG. 6 illustrates an example activity diagram 600 supporting distributed orchestration for a satellite group or other group according to this disclosure. For ease of explanation, the activity diagram 600 is described as being used with the satellites 102 in the system 100 of FIG. 1. However, the activity diagram 600 may be used with any other suitable satellites or other devices and in any other suitable systems.

As shown in FIG. 6, receipt of an information request causes a satellite 102 to become an auctioneer in state 602. The auctioneer satellite 102 sends a request for bid to one or more candidate satellites 102 in state 604. The auctioneer satellite 102 may identify the one or more candidate satellites 102 in any suitable manner, such as by identifying all other satellites 102 in the same constellation as the auctioneer satellite 102 or by identifying all other satellites 102 that are in the same constellation as the auctioneer satellite 102 and are in communication with the auctioneer satellite 102.

Each candidate satellite 102 can perform a feasibility assessment in state 606 and respond to the auctioneer satellite 102 with a bid or no bid. Any received bids are assessed in state 608 and ranked in state 610, and a winning bid is selected in state 612. The winning satellite 102 is notified in state 614 and can accept or reject the notification in state 616. If rejected, the auctioneer satellite 102 can select another winning bid in state 612 and notify another winning satellite 102 in state 614. Once a winning satellite 102 accepts the win notification, any additional actions may occur, such as providing the winning satellite 102 with the mission package.

Although FIG. 6 illustrates one example of an activity diagram 600 supporting distributed orchestration for a satellite group or other group, various changes may be made to FIG. 6. For example, the activity diagram 600 may involve any suitable number of satellites 102. Also, while it is assumed that the initial satellite 102 receiving the information request becomes the auctioneer, this may not necessarily be the case. In addition, while described as involving a satellite 102, the same or similar operations described in FIG. 6 may be used with other types of devices.

Note that various additional features may be implemented in a system that includes multiple satellites in a constellation or other devices in a group. For example, rather than having each participant satellite 102 determine whether one or more tasks are feasible, it may be possible to host the satellites' operating system on another device and determine generically through simulations whether each satellite may be capable of performing one or more specified tasks. As another example, multi-agent simulations may be used to evaluate edge cases (situations that may rarely occur), or reductions in services may be used when handling edge cases.

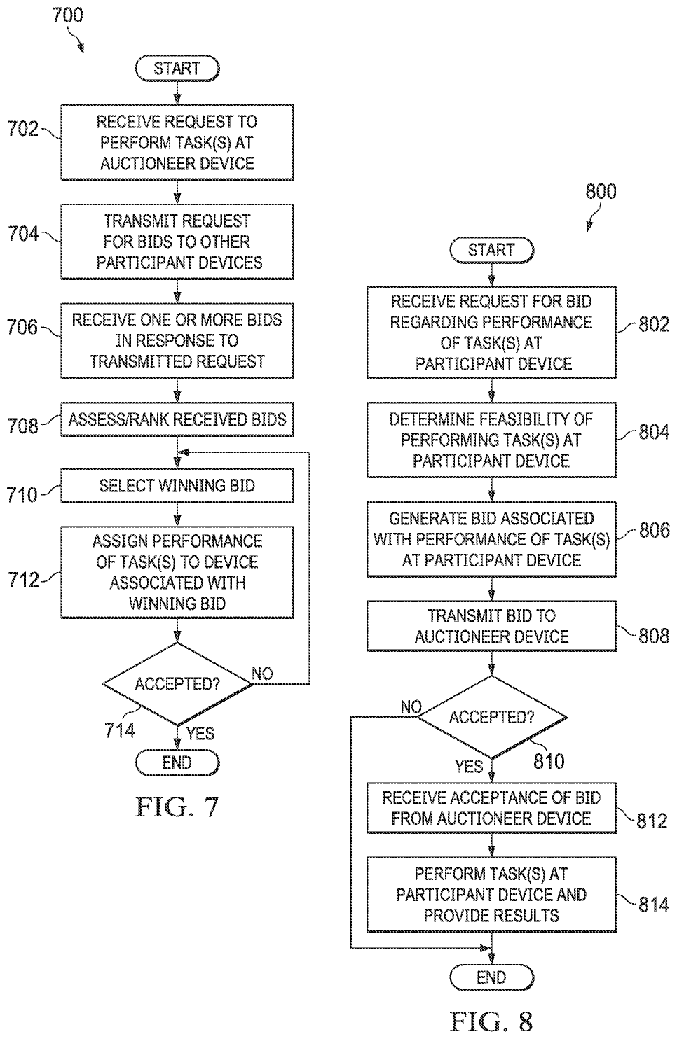

FIG. 7 illustrates an example method 700 for use by an auctioneering satellite or other device to support distributed orchestration for a satellite group or other group according to this disclosure. For ease of explanation, the method 700 is described as being performed by one of the satellites 102 in the system 100 of FIG. 1. However, the method 700 may be performed using any other suitable satellites or other devices and in any suitable systems.

As shown in FIG. 7, a request to perform one or more tasks is received at an auctioneer device at step 702. This may include, for example, the auctioneer satellite 102 receiving a mission package 306 or other information request 502 from a ground control system 106 or other source. A request for bids is transmitted from the auctioneer device to one or more other participant devices at step 704. This may include, for example, the auctioneer satellite 102 transmitting one or more requests 504 to one or more other participant satellites 102. One or more bids are received in response to the request at step 706. This may include, for example, the auctioneer satellite 102 receiving one or more bids 508 from at least one other participant satellite 102. This may also include the auctioneer satellite 102 generating its own bid 508 for performing the one or more tasks.

The auctioneer device assesses and ranks the received bids at step 708 (assuming more than one bid is obtained) and selects a winning bid at step 710. This may include, for example, the auctioneer satellite 102 ranking different bids in terms of quality and/or timeliness, where the ranking may be controlled (at least in part) on the preferences of the party who requested performance of the task(s). This may also include the auctioneer satellite 102 selecting the highest-ranked bid as the winning bid. Performance of the task(s) is assigned to the device with the winning bid at step 712. This may include, for example, the auctioneer satellite 102 transmitting a notification 514 and possibly other information (such as a mission package 306) to the wining satellite 102, assuming the auctioneer satellite 102 did not select its own bid as the winning bid. If the winning device accepts the assignment, the process ends. Otherwise, if the winning device rejects the assignment, the process can return to step 710, where the auctioneer device can select another winning bid (such as the next-highest ranked bid).

Although FIG. 7 illustrates one example of a method 700 for use by an auctioneering satellite or other device to support distributed orchestration for a satellite group or other group, various changes may be made to FIG. 7. For example, while shown as a series of steps, various steps in FIG. 7 may overlap, occur in parallel, occur in a different order, or occur any number of times. Also, while described as involving a satellite 102, the same or similar operations described in FIG. 7 may be used with other types of devices.

In addition, while it is often assumed here that the auctioneer satellite performs an auction automatically in response to a received request, that may not be the case. In other cases, for example, a satellite may receive a request and initially determine whether it can satisfy the request. If the satellite can satisfy the request, the satellite may not act as an auctioneer and not send requests to other satellites. The satellite may become an auctioneer and send requests to other satellites if and when the satellite determines that it cannot satisfy the request.

As an example of this, assume that a command and control center (such as one operated by a commander) sends a mission or other task request or other information request to a first asset, which may be within a region of interest. If the first asset determines that, under current conditions and constraints associated with the mission, it will not be able to perform the mission or that other assets exist in the region that are better suited to carry out the mission, the first asset may become an auctioneer device and perform the method 700 discussed above. In one particular example, the first asset may represent a fighter jet (such as an F-16) or other air asset that receives a commander's mission or other task request for urgent surveillance over an area within a region of interest. The request may include associated parameters for the mission, such as a time within which the mission needs to be completed, key features that need to be identified in the area, or a desired resolution of images/video feed. While the first asset may be equipped with many kinetic and non-kinetic effectors and sufficient firepower, it may not be equipped with all of the necessary sensors needed to carry out the requested surveillance mission, or it may simply not be able to complete the mission within the specified time given its current location relative to the desired area. In such a case, being aware that a number of other assets exist in the region, the first asset may transmit a request for bids to one or more other assets that could potentially carry out the mission. The first asset may then receive bids from the other assets and perform the remaining steps discussed above in connection with the method 700 to assign the mission to at least one other asset associated with the winning bid.

FIG. 8 illustrates an example method 800 for use by a participant satellite or other device to support distributed orchestration for a satellite group or other group according to this disclosure. For ease of explanation, the method 800 is described as being performed by one of the satellites 102 in the system 100 of FIG. 1. However, the method 800 may be performed using any other suitable satellites or other devices and in any suitable systems.

As shown in FIG. 8, a request to bid on the performance of one or more tasks is received at a participant device at step 802. This may include, for example, a participant satellite 102 receiving a request 504 from an auctioneer satellite 102. A feasibility of performing the one or more tasks at the participant device is determined at step 804. This may include, for example, the participant satellite 102 using a feasibility engine to determine the participant satellite's ability to perform the requested task(s) based on factors such as the satellite's ability to collect requested information, access to a specified area in terms of time and space, scheduling priorities, and quality of data collection. Assuming performance of the task(s) is feasible, a bid is generated for performance of the task(s) at step 806 and transmitted to the auctioneer device at step 808. This may include, for example, the participant satellite 102 generating a bid identifying the estimated quality and timeliness of the performance of the task(s) by the participant satellite 102.

Assuming the auctioneer device accepts the bid at step 810, an acceptance of the bid is received from the auctioneer device at step 812. This may include, for example, the participant satellite 102 receiving a notification 514 and possibly other information (such as a mission package 306) from the auctioneer satellite 102. Assuming the participant device accepts the winning notification, the one or more tasks are performed at the participant device and the results are output from the participant device at step 814. This may include, for example, the participant satellite 102 performing one or more data collection tasks or other tasks, optionally processing the collected information, and transmitting the collected or processed information (such as to the ground control system 106 or other destination). As noted above, however, the participant satellite 102 may reject the winning notification if needed or desired, such as due to changed circumstances of the participant satellite 102.

Although FIG. 8 illustrates one example of a method 800 for use by a participant satellite or other device to support distributed orchestration for a satellite group, various changes may be made to FIG. 8. For example, while shown as a series of steps, various steps in FIG. 8 may overlap, occur in parallel, occur in a different order, or occur any number of times. Also, while described as involving a satellite 102, the same or similar operations described in FIG. 8 may be used with other types of devices.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive (HDD), a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
receiving, at a specified device among a plurality of devices, a first request to perform a first task;
transmitting multiple bid requests associated with the first task to multiple other devices among the plurality of devices;
receiving, at the specified device, at least one bid response from at least one of the other devices; and
assigning performance of the first task to one or more of the plurality of devices based on the at least one bid response.

2. The method of claim 1, wherein each bid response comprises a quality and a timeliness associated with the one of the devices' ability to perform the first task.

3. The method of claim 2, wherein:
receiving the at least one bid response comprises receiving multiple bid responses; and
the method further comprises:
ranking the bid responses based on at least one quality or timeliness factor identified by a party providing the first request; and
selecting a winning bid response based on the ranking.

4. The method of claim 1, further comprising:
receiving, at the specified device from an auctioneer device among the plurality of devices, a second bid request associated with a second task to be performed;
determining that the specified device is capable of performing the second task;
transmitting a second bid response to the auctioneer device; and
in response to acceptance of the second bid response by the auctioneer device, performing the second task at the specified device.

5. The method of claim 4, wherein determining that the specified device is capable of performing the second task comprises:
determining that the specified device has a sensing capability, access, and priority that permits the second task to be performed by the specified device.

6. The method of claim 4, wherein determining that the specified device is capable of performing the second task comprises:
using a feasibility model to assess the specified device's ability to perform the second task based on (i) capabilities of the specified device and (ii) other tasks having a higher priority than the first task to be performed by the specified device.

7. The method of claim 1, wherein:
the plurality of devices comprises a plurality of satellites; and
the first request comprises a request to perform a data collection operation.

8. A device comprising:
at least one processor configured to:
receive a first request to perform a first task;
initiate transmission of multiple bid requests associated with the first task to multiple other devices;
receive at least one bid response from at least one of the other devices; and
assign performance of the first task to one or more of the plurality of devices based on the at least one bid response.

9. The device of claim 8, wherein each bid response comprises a quality and a timeliness associated with the one of the devices' ability to perform the first task.

10. The device of claim 9, wherein:
the at least one processor is configured to receive multiple bid responses; and
the at least one processor is further configured to:
rank the bid responses based on at least one quality or timeliness factor identified by a party providing the first request; and
select a winning bid response based on the ranking.

11. The device of claim 8, wherein the at least one processor is further configured to:
receive, from an auctioneer device, a second bid request associated with a second task to be performed;
determine that the device is capable of performing the second task;
initiate transmission of a second bid response to the auctioneer device; and
in response to acceptance of the second bid response by the auctioneer device, initiate performance of the second task.

12. The device of claim 11, wherein, to determine that the device is capable of performing the second task, the at least one processor is configured to determine that the device has a sensing capability, access, and priority that permits the second task to be performed by the device.

13. The device of claim 11, wherein, to determine that the device is capable of performing the second task, the at least one processor is configured to use a feasibility model to assess the device's ability to perform the second task based on (i) capabilities of the device and (ii) other tasks having a higher priority than the first task to be performed by the device.

14. The device of claim 8, wherein:
the device comprises a satellite; and
the first request comprises a request to perform a data collection operation.

15. A non-transitory computer readable medium containing instructions that when executed cause at least one processor to:
receive, at a specified device among a plurality of devices, a first request to perform a first task;
initiate transmission of multiple bid requests associated with the first task to multiple other devices among the plurality of devices;
receive, at the specified device, at least one bid response from at least one of the other devices; and
assign performance of the first task to one or more of the plurality of devices based on the at least one bid response.

16. The non-transitory computer readable medium of claim 15, wherein each bid response comprises a quality and a timeliness associated with the one of the devices' ability to perform the first task.

17. The non-transitory computer readable medium of claim 16, wherein:
the instructions when executed cause the at least one processor to receive multiple bid responses; and
further containing instructions when executed cause the at least one processor to:
rank the bid responses based on at least one quality or timeliness factor identified by a party providing the first request; and
select a winning bid response based on the ranking.

18. The non-transitory computer readable medium of claim 15, further containing instructions when executed cause the at least one processor to:
receive, from an auctioneer device, a second bid request associated with a second task to be performed;
determine that the device is capable of performing the second task;
initiate transmission of a second bid response to the auctioneer device; and
in response to acceptance of the second bid response by the auctioneer device, initiate performance of the second task.

19. A method comprising:
receiving, at a specified device from an auctioneer device, a request associated with a task to be performed;
determining that the specified device is capable of performing the task;
transmitting a bid response to the auctioneer device; and
in response to acceptance of the bid response by the auctioneer device, performing the task at the specified device.

20. The method of claim 19, wherein determining that the specified device is capable of performing the task comprises:
determining that the specified device has a sensing capability, access, and priority that permits the task to be performed by the specified device.
